(19) United States
(12) Patent Application Publication
(10) Pub. No.: US 2007/0272743 A1
(43) Pub. Date: Nov. 29, 2007

(54) Kiosk and Method for Vending Stored Value Cards

(75) Inventors: Jonathan Ross Christie, New York, NY (US); Mario Furgiuele, Toronto (CA); Elizabeth Ann Gelb-O'Connor, Chatham, NJ (US); Amit Sachdev, Franklin Park, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/752,134

(22) Filed: May 22, 2007

Related U.S. Application Data
(60) Provisional application No. 60/802,104, filed on May 22, 2006.

(51) Int. Cl. G06F 7/08

(52) U.S. Cl. 235/381

(57) ABSTRACT

A kiosk machine vends stored value cards (i.e., pre-paid and gift cards). The kiosk is self-service and will allow a user to select, purchase and pay for a stored value card without requiring the presence or assistance of a sales clerk. The kiosk can vend one or more cards in a single transaction. The kiosk is a computer-based vending machine having a touch-sensitive video screen and a card reader. The touch screen provides a user interface for a user to receive information and provide input selections. The card reader can be used to read a transaction card (e.g., an American Express card or credit card) to facilitate payment for the stored value card(s) being purchased. The vending method comprises: providing a kiosk having a user interface; receiving, via the user interface, a request to purchase a stored value card, receiving payment for the purchase; determining a card number associated with a selected card; activating the selected card to produce an activated stored value card in the card denomination; and dispensing the activated stored value card. A user purchasing a stored value card can select a type of stored value card, wherein the type is selected from the group consisting of an open card and a closed card. The closed card can be of the type usable only in a shopping center where the kiosk is physically located. The user can further select a card denomination. The method further allows a user to check a card balance for a stored value card.

### CROSS REFERENCE TO RELATED APPLICATIONS

This patent application claims priority under 35 U.S.C. §119(e) to U.S. Provisional Appl. No. 60/802,104, filed May 22, 2006, which is incorporated herein by reference as if reproduced in full below.

### BACKGROUND OF THE INVENTION

1. Field of the Invention

The present invention relates to stored value or pre-paid gift cards, and more particularly, to a kiosk and method for vending stored value or pre-paid gift cards.

2. Related Art

Stored value cards (e.g., pre-paid gift cards) are typically purchased at a point of sale through a sales clerk. For example, a consumer will indicate to a sales clerk at the point of sale that a stored value card is desired. The sales clerk will then ask the consumer to select a denomination (i.e., a currency amount or value to be associated with the card). After the denomination is established and payment for the card is made, the sales clerk will take a inactivated stored value card from a stockpile of cards, activate the card with the desired amount, and give the card to the consumer. Alternatively, the sales clerk may have a stockpile of stored value cards in pre-denominated amounts. When the consumer selects the desired denomination, the sales clerk need only receive payment and activate the card having the desired denomination.

In yet another example, there may be a display case of stored value cards. The display case might have pre-denominated cards, variable load cards, or even a mixture of both types. The consumer chooses the desired card from the display case and then brings the card to a sales clerk for payment and activation. For obvious security reasons, the cards are not activated until the consumer pays for the card and the sales clerk activates it.

These examples of card purchasing can be time-consuming for both the sales clerk and the consumer. Moreover, if a consumer visits a store for the sole purpose of purchasing a stored value card, it is desirable that the consumer not have to wait in a queue with other consumers who may be making more time-consuming purchases, thereby delaying purchase of the stored value card. In some stores, stored value cards are sold only at customer service desks, which are frequently understaffed and typically have slow moving queues.

Given the foregoing, what is needed is a system and method for vending stored value cards that overcomes these and other deficiencies.

### SUMMARY OF THE INVENTION

The present invention is a kiosk machine and method for vending (i.e., selling) stored value cards. The kiosk is self-service and will allow a user to select, purchase and pay for a stored value card without requiring the presence or assistance of a sales clerk. The kiosk can vend one or more cards in a single transaction. The kiosk can also vend different types of cards. For example, the stored valued cards being sold can include pre-denominated cards (e.g., cards with fixed values such as $20, $50 or $100 cards) or variable load cards (i.e., a card having a pre-paid value selected by the purchaser). Furthermore, the cards can be open system cards such as American Express Gift Cards that may be used at any location that an American Express Card is accepted, or the cards may be closed system cards. An example of a closed system card is a gift card that can only be used, for example, in one (or more) of the stores in the mall where the card was purchased.

The kiosk of the invention will provide customers a more positive experience by taking them out of the queue at the customer service desk of a retail store and will decrease transaction time for purchasing a gift card. The kiosk of the invention will also provide sellers with the benefit of reduced selling cost and ease of management.

In an embodiment, the kiosk is a computer-based vending machine having a touch-sensitive video screen (i.e., touch screen) and a card reader. The touch screen provides a user interface for a customer to receive information and provide input selections. The card reader can be used to read a transaction card (e.g., an American Express card) to facilitate payment for the stored value card(s) being purchased.

The kiosk will communicate via secure electronic communications with a card transaction processing system, such as UltraPoS, which will perform the processing of the pre-paid card transactions. The UltraPoS system is available from Stanton Consultancy Ltd. (SCL), Brighton, East Sussex, UK.

A method for automatically vending a stored value card according to the invention comprises: providing a kiosk having a user interface; receiving, via the user interface, a request to purchase a stored value card; receiving payment for the purchase; determining a card number associated with a selected card; activating the selected card to produce an activated stored value card in the card denomination; and dispensing the activated stored value card. A user purchasing a stored value card can select a type of stored value card, wherein the type is selected from the group consisting of an open card and a closed card. The closed card can be, for example, of a type usable only in a shopping center where the kiosk is physically located. The user can further select a card denomination. The method further allows a user to check a card balance for a stored value card.

The method further includes providing a user with an optional survey about the user's experience in using the kiosk. Survey results are uploaded to a remote server for analysis.

### BRIEF DESCRIPTION OF THE FIGURES

The features and advantages of the present invention will become apparent from the detailed description set forth below, when taken in conjunction with the drawings in which like reference numbers indicate identical or functionally similar elements. Additionally, the left-most digit of a reference number identifies the drawing in which the reference number first appears.

FIG. 1 is a perspective view of a kiosk according to an embodiment of the invention.

FIG. 2 is a block diagram illustrating the functional components of a kiosk according to an embodiment of the invention.

FIGS. 3-15 are flowcharts illustrating operation of a kiosk according to an embodiment of the invention.

FIG. 16 is a block diagram illustrating communication between a kiosk, an administrator, a transaction processing system, and an account manager for registration of a kiosk according to an embodiment of the invention.

FIG. 17 is a block diagram illustrating communication between a kiosk and a transaction processing system for logon and authentication according to an embodiment of the invention.

FIG. 18 is a block diagram illustrating communication between a kiosk, a transaction processing system, and an issuing institution in connection with sale of a stored value card according to an embodiment of the invention.

FIG. 19 is a block diagram illustrating communication between a kiosk, a transaction processing system, and a payment processor in connection with sale of a stored value card according to an embodiment of the invention.

FIG. 20 is a block diagram illustrating communication between a transaction processing system and an issuing institution in connection with settlement and inventory load according to an embodiment of the invention.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” and/or the plural form of these terms are used interchangeably herein to refer to those persons or entities capable of accessing, using, being affected by and/or benefiting from the present invention. Furthermore, the terms “service provider,” “business” or “merchant” may be used interchangeably with each other and shall mean any person, entity, distributor system, software and/or hardware that is a provider, broker and/or any other entity in the distribution chain of goods or services. For example, a service provider may be a hotel company, an airline company, a travel agency, an on-line merchant or the like.

A “transaction account” as used herein refers to an account associated with an open account or a closed account system, as described below. The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a stored value card that may only be purchased at, and only be accepted at, a clothing retailer, such as The Gap® store. Another example of a closed card is a stored value card that can only be used at a merchant in a particular shopping center (also referred to herein as a shopping mall).

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars. Stored value cards may be open or closed.

With regard to use of a transaction account, users may communicate with service providers in person (e.g., at the box office), telephonically, or electronically (e.g., from a user computer via the Internet). During the interaction, the service provider may offer goods and/or services to the user. The service provider may also offer the user the option of paying for the goods and/or services using any number of available transaction accounts. Furthermore, the transaction accounts may be used by the service provider as a form of identification of the user. The service provider may have a computing unit implemented in the form of a computer-server, although other implementations are possible.

In general, transaction accounts may be used for transactions between the user and service provider through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account,” “account number” or “account code,” as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

It should be noted that the transfer of information in accordance with the present invention may be done in a format recognizable by a merchant system or account issuer. In that regard, by way of example, the information may be transmitted from an RFID device to an RFID reader, or from the RFID reader to the merchant system in magnetic stripe or multi-track magnetic stripe format.

Because of the proliferation of devices using magnetic stripe format, the standards for coding information in magnetic stripe format were standardized by the International Organization for Standardization in ISO/IEC 7811-n (characteristics for identification cards) which are incorporated herein by reference. The ISO/IEC 7811 standards specify the conditions for conformance, physical characteristics for the card (warpage and surface distortions) and the magnetic stripe area (location, height and surface profile, roughness, adhesion, wear and resistance to chemicals), the signal amplitude performance characteristics of the magnetic stripe, the encoding specification including technique (MFM), angle of recording, bit density, flux transition spacing variation and signal amplitude, the data structure including track format, use of error correction techniques, user data capacity for ID-1, ID-2 and ID-3 size cards, and decoding techniques, and the location of encoded tracks.

Typically, magnetic stripe information is formatted in three tracks. Certain industry information must be maintained on certain portions of the tracks, while other portions of the tracks may have open data fields. The contents of each track and the formatting of the information provided to each track is controlled by the ISO/IEC 7811 standard. For example, the information must typically be encoded in binary. Track 1 is usually encoded with user information (i.e., name) in alphanumeric format. Track 2 is typically comprised of discretionary and nondiscretionary data fields. In one example, the nondiscretionary field may comprise 19 characters and the discretionary field may comprise 13 characters. Track 3 is typically reserved for financial transactions and includes enciphered versions of the user's personal identification number, country code, current units amount authorized per cycle, subsidiary accounts, and restrictions.

As such, where information is provided, it may be provided in magnetic stripe track format. For example, the counter values, authentication tags and encrypted identifiers may be forwarded encoded in all or a portion of a data stream representing data encoded in, for example, track 2 or track 3 format.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

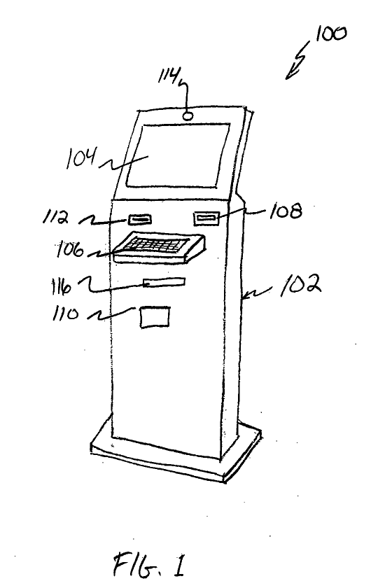

FIG. 1 shows a kiosk 100 in accordance with an example embodiment of the invention. Kiosk 100 includes a housing or chassis 102, a display 104, a keyboard 106, a transaction card reader 108, a card dispenser 110, a bill acceptor 112 and a camera 114. Kiosk 100 can be a commercially available kiosk which has been modified or adapted in accordance with the invention described herein. For example, kiosk 100 can be based on a commercially available kiosk of the type used to dispense prepaid calling cards, commuter rail passes, and other merchandise. For example, see the kiosks described in U.S. Pat. No. 6,575,362 and U.S. Pat. No. 7,014,108. In one embodiment, kiosk 100 is based on, for example, a PLYNTH G5 series kiosk available from King Products and Solutions, Inc. of Mississauga, Ontario Canada. Kiosk 100 can also be based on an automated teller machine (ATM) type kiosk.

In the example embodiment of kiosk 100, display 104 is a TFT active matrix LCD XGA (1024×768) display providing a touch screen that is used as both an input device and an output device for kiosk 100. That is, a menu for options is displayed to a user on display 104, and the user may touch the screen to select menu options.

Keyboard 106 is a standard, QWERTY keyboard that allows a user to provide input to kiosk 100. Keyboard 106 is optional and may be omitted, especially when display 104 is a touch screen device.

Card reader 108 is a conventional magnetic stripe card reader of the type used to read the magnetic stripe on transaction cards. Card reader 108 may also be of the type that can read optical cards (e.g., barcodes), smartcards, and RFID (Radio Frequency Identification) cards. Card reader 108 is used to accept transaction cards which act as a payment vehicle or payment means for purchase of a stored value card from kiosk 100. As an alternative or addition to card reader 108, kiosk 100 may include a bill acceptor 112. Bill acceptor 112 can accept currency to allow a user to pay for a transaction using currency. Bill acceptor 112 may further be configured to accept coins and to make change.

Camera 114 is an optional feature of kiosk 102. Camera 114 is a digital camera that can be used to capture photographic images of a user in connection with a stored value card transaction. Photograph images captured in connection with a stored value card transaction can be stored in a database for use in connection with theft and/or fraud detection and prevention.

Kiosk 100 may further include a printer 116 to print transaction receipts. For example, printer 116 may be a thermal printer.

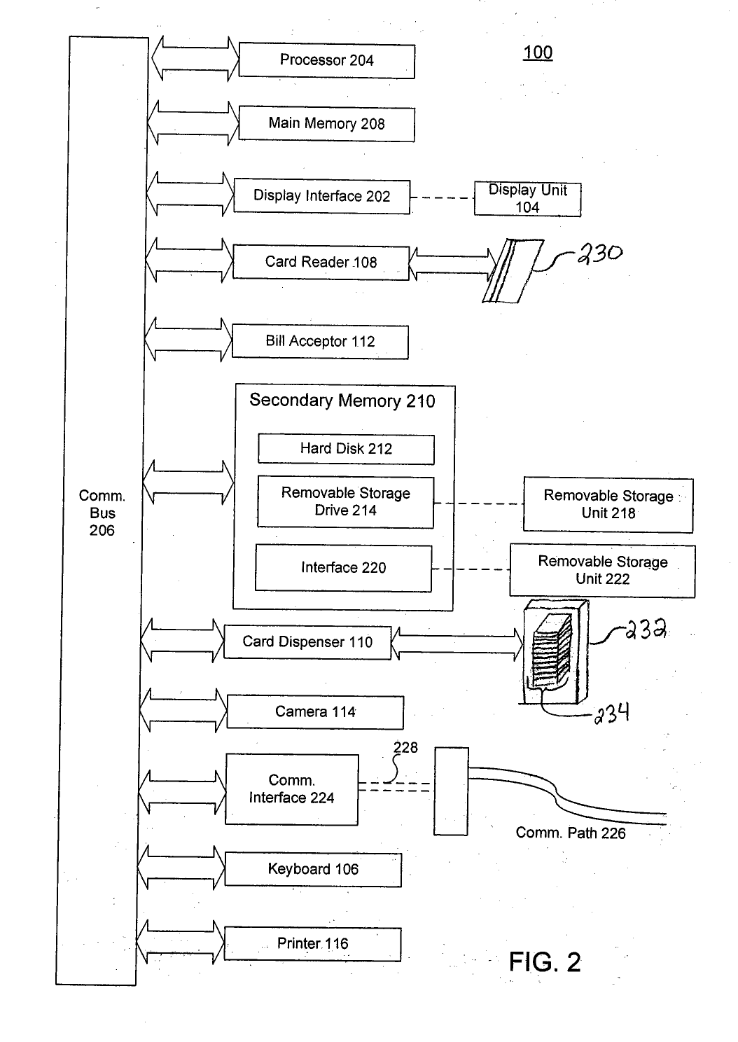

FIG. 2 is a block diagram illustrating the functional components of kiosk 100 according to this example embodiment of the invention. Operation of kiosk 100 is described in terms of this exemplary computer-based system. After reading this description, it will become apparent to a person skilled in the relevant art(s) how to implement the invention using other computer-based systems and/or architectures.

As shown in FIG. 2, kiosk 100 includes one or more processors, such as processor 204.

Processor 204 is connected to a communication infrastructure 206 (e.g., a communications bus, cross-over bar, or network). A display interface 202 forwards graphics, text, and other data from communication infrastructure 206 for display on display unit 104. Kiosk 100 also includes a main memory 208, preferably random access memory (RAM), and may also include a secondary memory 210. Secondary memory 210 may include, for example, a hard disk drive 212 and/or a removable storage drive 214, representing a floppy disk drive, a magnetic tape drive, an optical disk drive, etc. Removable storage drive 214 reads from and/or writes to a removable storage unit 218 in a well known manner. Removable storage unit 218 represents a floppy disk, magnetic tape, optical disk, etc. which is read by and written to by removable storage drive 214. As will be appreciated, removable storage unit 218 includes a computer usable storage medium having stored therein computer software and/or data.

In alternative embodiments, secondary memory 210 may include other similar devices for allowing computer programs or other instructions to be loaded into kiosk 100. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from removable storage unit 222 to kiosk 100.

Kiosk 100 also includes a communications interface 224. Communications interface 224 allows software and data to be transferred between kiosk 100 and external devices. Examples of communications interface 224 include a modem, a network interface (such as an Ethernet card), a communications port, a Personal Computer Memory Card International Association (PCMCIA) slot and card, etc. Software and data transferred via communications interface 224 are in the form of signals 228 which may be electronic, electromagnetic, optical or other signals capable of being received by communications interface 224. These signals 228 are provided to communications interface 224 via a communications path (e.g., channel) 226. This channel 226 carries signals 228 and may be implemented using wire or cable, fiber optics, a telephone line, a cellular link, an radio frequency (RF) link and other communications channels.

As described in additional detail below, kiosk 100 communicates with one or more remote computers (also called “server computers” or “web servers”) via a network such as the Internet or a dedicated communication channel to (1) process transaction card based payments for purchase of a stored value card; (2) to active a stored value card; and (3) to check the balance on a stored value card. Such communication will typically involved packet-based digital communications (e.g., using TCP/IP protocols) and will typically use data encryption or other means for data security. For example, communications interface 224 can be an Ethernet card in communication with a local area network (LAN) in a shopping center which communicates over the Internet to one or more remote server computers.

In this document, the terms “computer program medium” and “computer usable medium” are used to generally refer to media such as removable storage drive 214, a hard disk installed in hard disk drive 212, and signals 228. These computer program products provide software to kiosk 100. The invention includes such computer program products.

Computer programs (also referred to as computer control logic) are stored in main memory 208 and/or secondary memory 210. Computer programs may also be received via communications interface 224. Such computer programs, when executed, enable kiosk 100 to perform the features of the present invention, as discussed herein. In particular, the computer programs, when executed, enable processor 204 to perform the features of the present invention. Accordingly, such computer programs represent controllers of kiosk 100.

In an embodiment where the invention is implemented using software, the software may be stored in a computer program product and loaded into kiosk 100 using removable storage drive 214, hard drive 212 or communications interface 224. The control logic (software), when executed by processor 204, causes processor 204 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). In yet another embodiment, the invention is implemented using a combination of both hardware and software.

Card reader 108, card dispenser 110, bill acceptor 112, camera 114, keyboard 106 and printer 116 also communicate with communication infrastructure 206 and are under control of processor 204. As shown in FIG. 2, card reader 108 is configured to read a card 230. Card 230 is a transaction card that may be used for payment in connection with a stored value card purchase.

Bill acceptor 112, under control of processor 204, is configured to accept paper currency for payment of a stored value card purchase. As indicated above, bill acceptor 112 may also include a coin acceptor and have the ability to provide change.

Card dispenser 110, under control of processor 204, is a robotic assembly configured to retrieve a stored value card from stored value cardstock 234 in a card hopper 232. Kiosk 100 may include a plurality of card hoppers 232, each card hopper being configured to store cards of a different denomination. For example, a first card hopper 232 can be used to hold stored value cards having a $50 denomination and a second card hopper 232 can be used to hold stored value cards having a $100 denomination. Card dispenser 110 is a conventional card handling device that includes the appropriate electric motors and/or robotic devices to retrieve a stored value cardstock from a hopper 232 and dispense it to a user in connection with purchase of a stored value card.

Stored value cardstock 234 may be any type of transaction card (e.g., a smartcard, an RFID card, an optically readable card, a plastic card having a magnetic stripe, and the like as described above). In addition, stored value cardstock 234 may be embossed or non-embossed. Furthermore, stored value cardstock may include fixed denomination cards or variable load cards. In one embodiment, the cards are placed in hopper 232 in a particular order so that, as each card is retrieved from the hopper for activation, its number is known based on the relative position of the card in the hopper. For example, the identification number can be looked up in a database based on the position of the card in the hopper. In another embodiment, card dispenser 110 may include a card reader (or may employ card reader 108) to read the card number from a selected stored value cardstock 234 in connection with the activation process.

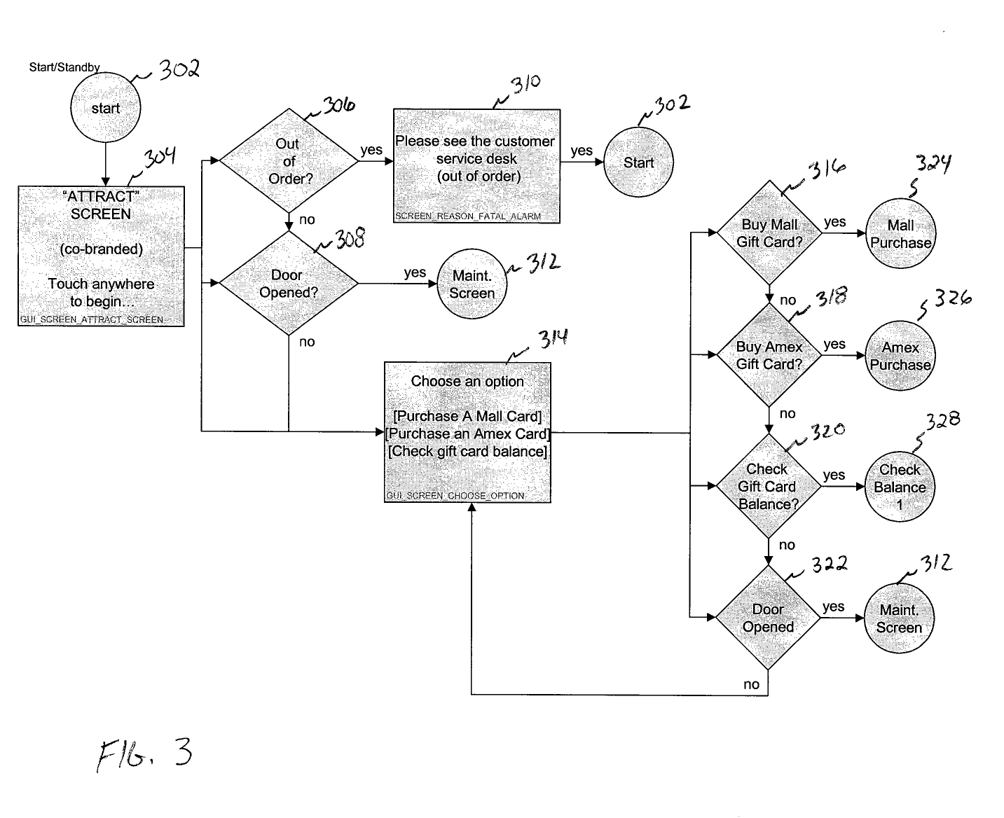

Operation of kiosk 100 in an example embodiment and an example environment is described below with reference to FIGS. 3-15. In FIGS. 3-15, the substantially square-shaped boxes generally represent a message to be displayed to a user of the kiosk, the diamond-shaped boxes generally represent a decision point or option selection made by a user, the thin rectangular-shaped boxes generally represent an action being taken by the kiosk, and the circular-shapes generally represent a jump point to/from another flowchart.

In this example environment, kiosk 100 is located in a shopping mall and has been configured to dispense both American Express gift cards (i.e., open stored value cards) and mall-specific gift cards (i.e., closed stored value cards). In this example environment, the mall gift card may only be used in retail stores within the shopping mall, while the American Express gift card is an open card that can be used in any store accepting American Express cards. FIGS. 3-15 are flowcharts showing the steps performed by kiosk 100 in displaying information to, and receiving choice selections from, a user in connection with the purchase of a stored value card. For ease of explanation, the stored value cards in this example environment will be described as “AMEX gift cards” and “Mall gift cards.”

Referring first to FIG. 3, the process starts at step 302. In step 304 an attract (eye catching) screen is displayed on the display to attract a user to the kiosk. A user touching the screen of the display will advance the method to the next step. In steps 306 and 308, proper operation of the kiosk is checked. If the kiosk is out-of-order, an appropriate message is displayed at step 310 and the process returns to step 302. If the service door of the kiosk is open, the process will proceed to a maintenance screen at step 312. If the kiosk is neither out-of-order nor open for a maintenance operation, then an option is provided to the user at step 314 to purchase a card or check a card balance. At step 322, it is again checked to determine whether the door of the kiosk is open. If the door is open, then the method proceeds to step 312. At steps 316-320, it is determined whether the user has selected purchase of a mall gift card, purchase of an AMEX gift card, or a balance inquiry/check. If purchase of a mall gift card is selected, the method proceeds to step 324. If purchase of an AMEX gift card is selected, the method proceeds to step 326. If gift card balance check is selected, the method proceeds to step 328.

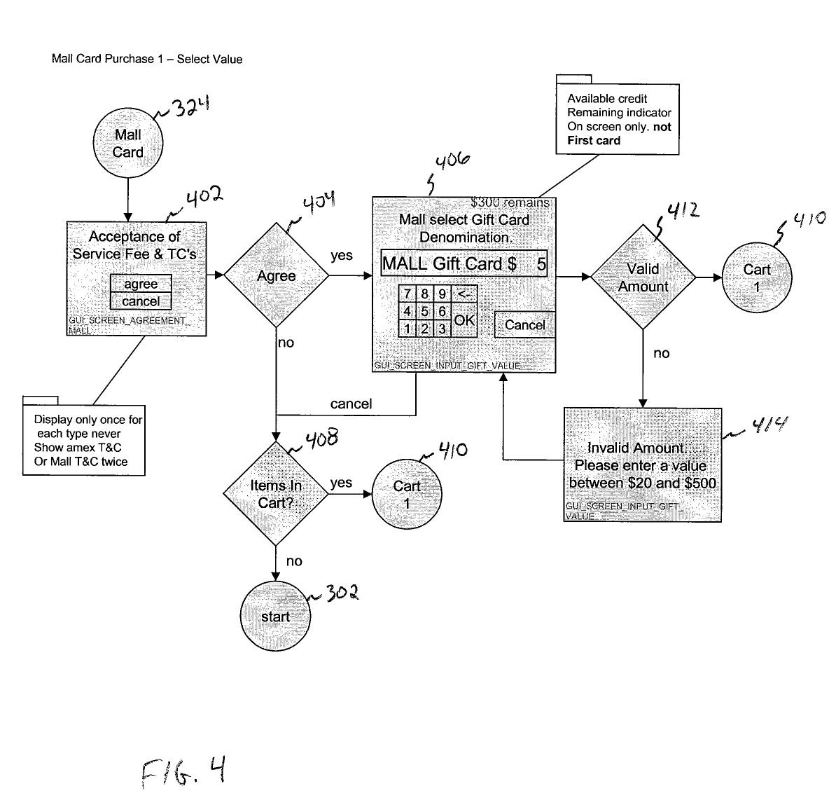

Processing of a purchase of a mall gift card from step 324 continues in FIG. 4. At step 402, a screen is displayed to the user concerning service fees associated with the purchase of the gift card as well as the terms and conditions of the purchase. At step 404, it is determined whether the user has agreed to the service fee and terms and conditions of purchase. If the user has agreed, the method proceeds to step 406. If the user does not agree, the method proceeds to step 408. In step 406, the user selects the gift card denomination. Step 412 then determines whether the amount selected is valid. If a valid amount is not selected, the method proceeds to step 414 which provides a message to the user to select a valid amount. The method then returns to step 406. If a valid amount is selected as determined at step 412, the method proceeds to step 410.

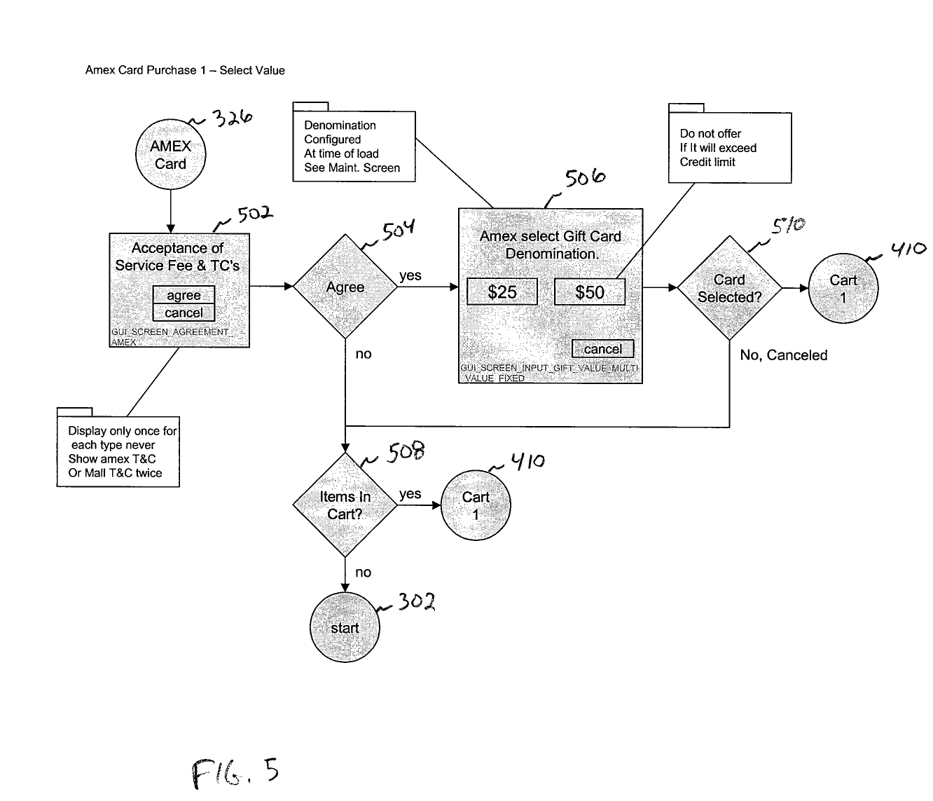

Processing of an AMEX gift card selection from step 326 is shown in FIG. 5. Steps 502, 504 and 508 are similar to steps 402, 404 and 408 of FIG. 4. In step 506, the user is prompted to select a gift card denomination. In this example, step 506 offers only fixed denomination cards to the user. In another example, variable denomination gift cards could also be offered. In step 510 it is determined whether a card was selected in step 506. If no card is selected, the transaction is cancelled and the method proceeds to step 508. If a card has been selected, the method proceeds to step 410.

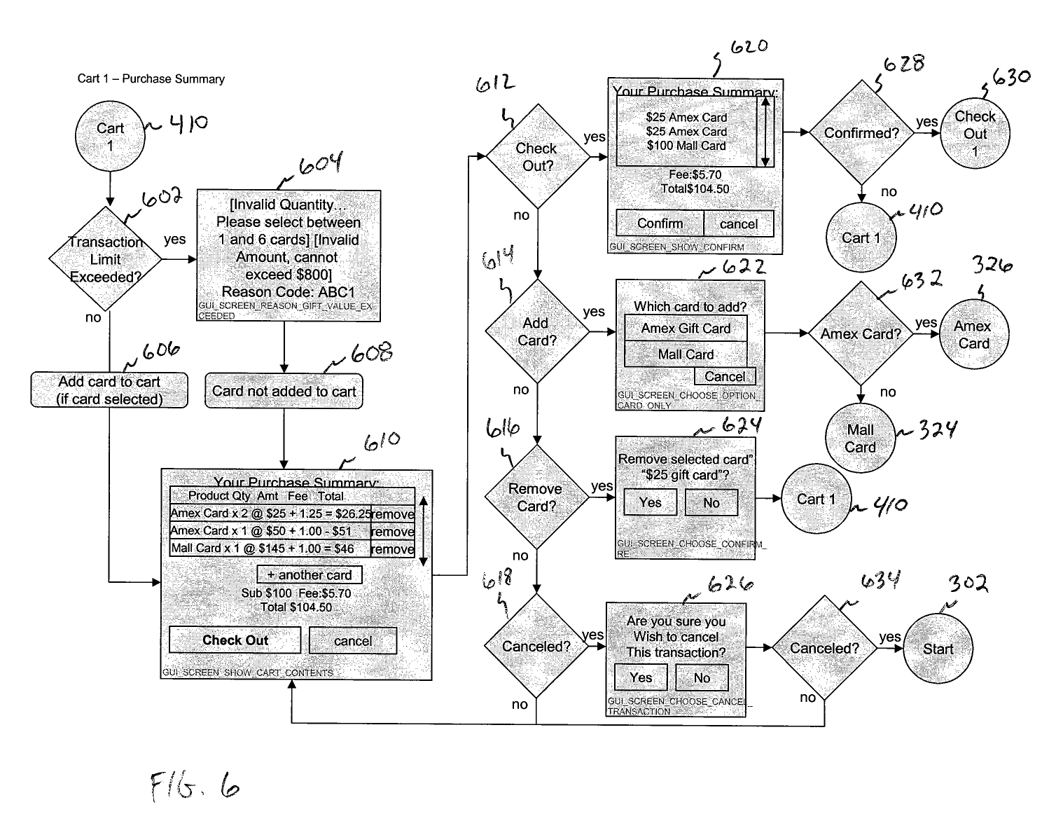

A purchase summary portion of the method continuing from step 410 is shown in FIG. 6. In step 602, it is determined whether the transaction limit has been exceeded. For example, the transaction may be limited to a purchase of no more than six cards and a purchase amount not exceeding $800.00. If the transaction limit has been exceeded, a message is displayed to the user at step 604. Then at step 608, it is indicated that another card cannot be added to the shopping cart. If the transaction limit has not been exceeded, the method proceeds to step 606 where the indicated card is added to the shopping cart. From either of steps 606 and 608, the method proceeds to step 610 where a purchase summary is provided to the user, and the user is given the option of adding another card, checking out, or canceling the purchase. The method then proceeds to step 612 where the user is given an option to check out. If the user indicates the choice of checking out, the method proceeds to step 620 where the user is provided with a purchase summary and asked to confirm the transaction. If the transaction is confirmed at step 628, the method proceeds to a checkout as indicated at step 630. Otherwise, a method returns to step 410.

Returning to step 612, if a user indicates that checkout is not desired, the user is prompted at step 614 to add another card. If the user opts to add another card, the user is given the choice of which card to add at step 622. At step 632, it is determined whether the card to be added is an AMEX gift card or a mall gift card. If an AMEX gift card is selected, the method proceeds to step 326. If a mall gift card is selected, the method proceeds to step 324.

Returning to step 614, if a user selects the option of not adding an additional card the method proceeds to step 616, where the user is given the option of removing a card. At step 624 the user is presented with a list of cards in the shopping cart and is allowed to select the card to be removed. The method then proceeds to step 410.

If, at step 616, the user does not indicate that a card should be removed, the method proceeds to step 618. In step 618, it is determined whether the user selected at step 610 to cancel the transaction. If the user selected to cancel a transaction, then the choice is confirmed at step 626. If cancellation is selected, as indicated at step 634, the method proceeds to step 302. If cancellation was not selected, the method returns to step 610.

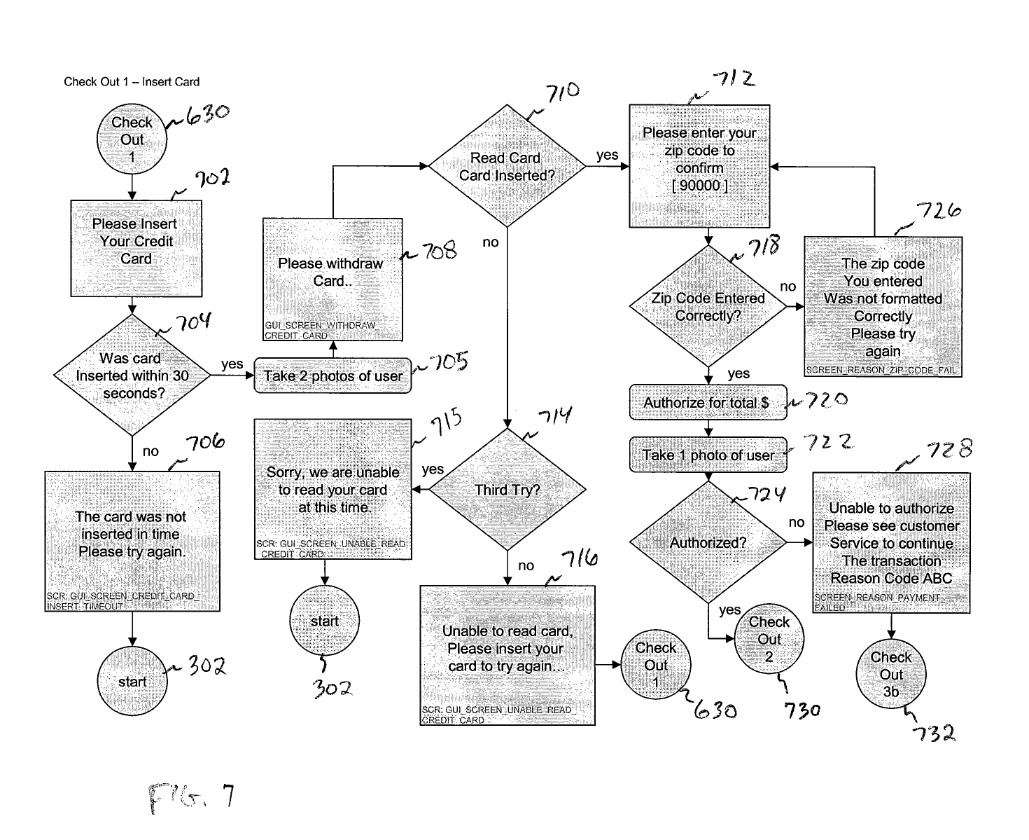

A checkout portion, corresponding to step 630 of the method, continues in the flowchart of FIG. 7. In step 702, a user is prompted to insert a credit card or other transaction card for payment. In another embodiment, a user can also be prompted to insert cash into the bill acceptor. In step 704, it is determined whether a card was inserted within a predetermined time period. If a card is not inserted within a predetermined time period, the method proceeds to step 706 where a message is displayed to the user. The method then returns to step 302. If it is determined in step 704 that a card was inserted within the predetermined time period, the method advances to step 705.

In step 705 one or more digital photographs are taken of the user for security and/or fraud prevention purposes. These photographs may be stored in a database that is correlated with the transaction. The method then proceeds to step 708 where the user is prompted to withdraw the card from the card reader. In step 710, it is determined whether the card from step 702 was properly read. If not, the method proceeds to step 714. In step 714, is determined whether this card read is the third try. If yes, a message is displayed to the user that the kiosk is unable to read the card. The method then returns to step 302. If the card read is not the third try, then the method proceeds to step 716 where a message is displayed to the user to reinsert the card for another attempt at reading the card. The method then proceeds to step 630.

If, at step 710, the read was successful, then the method proceeds to step 712 where the user is asked to enter additional identification information such as a billing address zip code. If it is determined at step 718 that the zip code is entered correctly, then the method proceeds to step 720. If the zip code was not entered correctly, a message is presented to the user in step 726, and the method returns to step 712. At step 720, authorization for the credit card transaction is requested according to normal credit card processing procedures. For example, the kiosk communicates with a payment gateway such as http://www.auth.net.

In step 722, an additional photograph is taken of the user for security and/or fraud prevention purposes. At step 724, it is determined whether the transaction card (e.g., credit card) transaction has been authorized. If the authorization was not successful, a user is presented with a message at step 728 and the method proceeds to step 732. If the authorization was successful, the method proceeds to step 730.

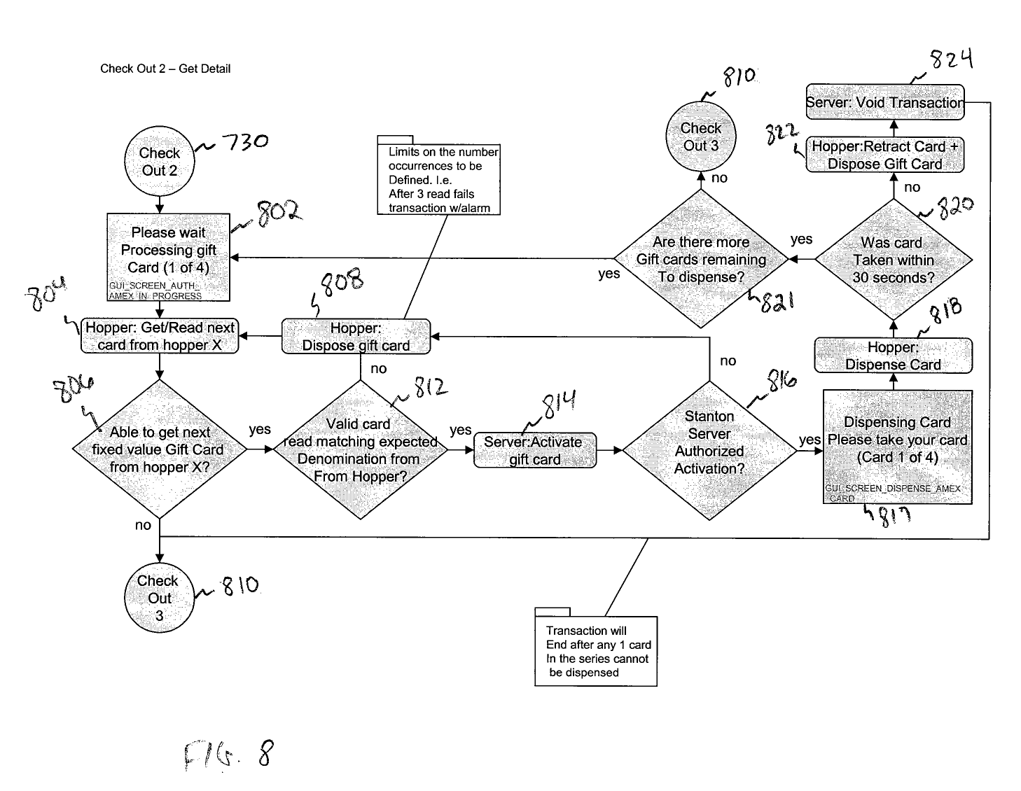

In FIG. 8, the checkout portion of the method from step 730 proceeds to step 802. In step 802, a “wait” message is displayed to the user while processing continues. In step 804, a stored value cardstock “i.e., an un-activated stored value card” is selected from the hopper. In step 806 it is determined whether a card was successfully retrieved in step 804. If card retrieval was not successful, the method proceeds to step 810. If card retrieval was successful, the method proceeds to step 812 where it is determined whether the fetched card has a denomination (“i.e., a value) matching what was expected. If the value does not match the expected value, the method returns to step 804 via step 808. In step 808, the non-matching card is disposed of (e.g., placed into a waste pile for later destruction.) If the card matching is successful in step 812, the card is activated in step 814. In step 816, it is determined whether the activation was successful. If not, the method proceeds to step 808. If activation was successful, a message is provided to the user that the card is being dispense. The card is then dispensed in step 818. At step 820, it is determined whether the user removed the card from the dispenser within a predetermined time period. If a card is not removed from the dispenser within a predetermined time period, the card is retracted from a position of user access in step 822, the transaction is voided in step 824, and the method proceeds to step 810. If the card is taken within the predetermined time period, the method proceeds to step 821 where it is determined whether there are additional cards to be dispensed. If there are not additional cards to be dispensed, the method proceeds to step 810. If there are additional cards to be dispensed, the method returns to step 802.

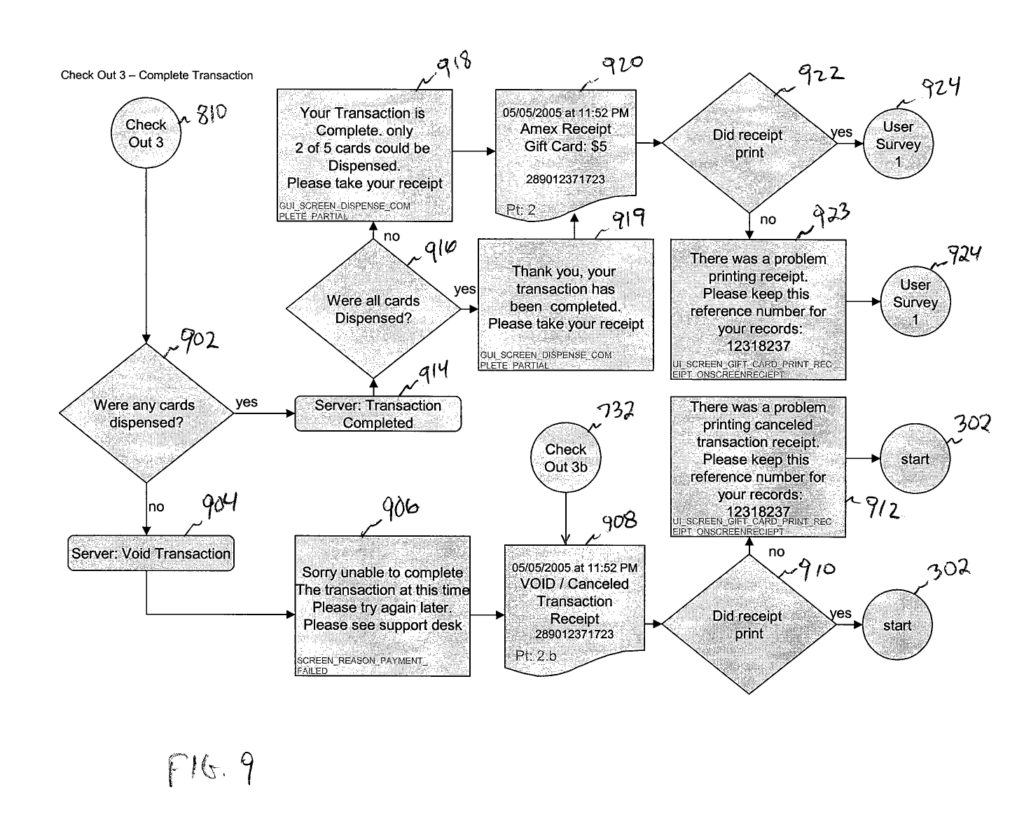

FIG. 9 shows the portion of the method continuing from step 810 where the stored value card purchase is completed. At step 902 it is determined whether any cards were dispensed. If no cards were dispensed, the transaction is voided at step 904, a message is presented to the user at step 906, a void/cancellation receipt is provided to the user in step 908 and it is determined that step 910 whether the receipt printed properly. If the receipt printed properly, the method returns to step 302. If the receipt did not print properly, at step 912 a message is provided to the user that there was a printing problem and a reference number is presented to the user via the display. The method then proceeds to step 302.

If, at step 902, cards were dispensed, then the method proceeds to step 914 where the transaction is completed. If, at step 916, all cards have been dispensed then a “thank you” message is provided to the user at step 919 and the method proceeds to step 920. If not all cards were dispensed at step 916, a message is presented to the user at step 918 indicating that the transaction only partially completed. A receipt is then provided to the user in step 920. At step 922 it is determined whether the receipt printed. If the receipt did not print, then a reference number is provided to the user via the display at step 923. If the receipt did print properly, then the method proceeds to step 924.

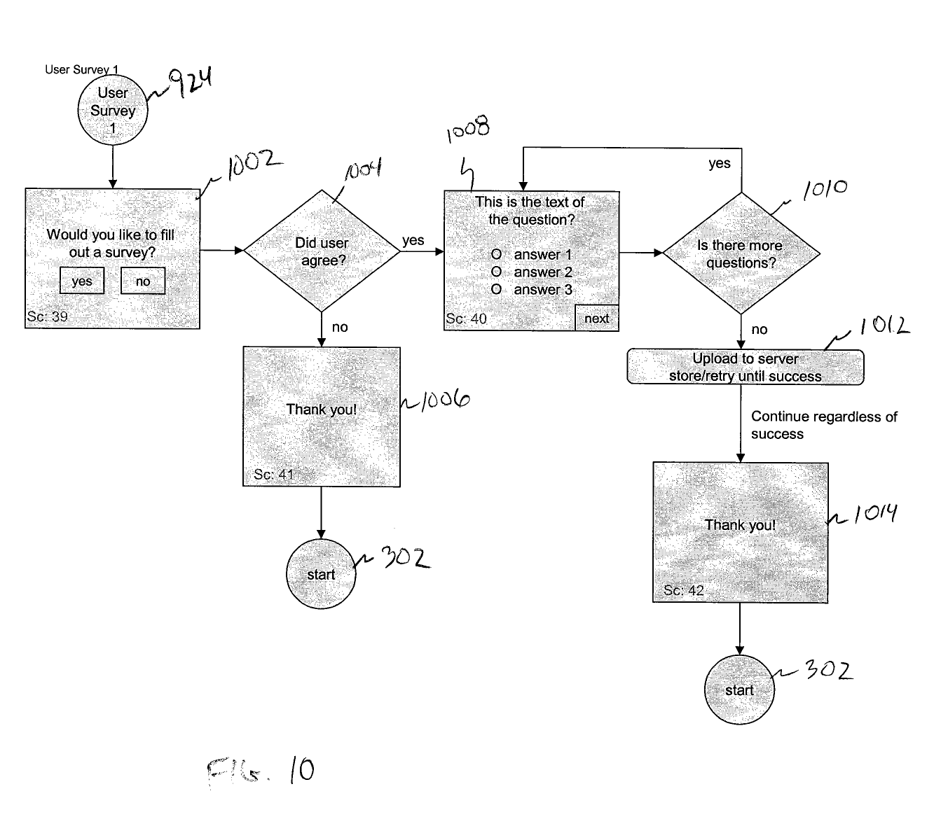

FIG. 10 shows a portion of the method commencing from step 924 where a user is asked to participate in a survey concerning their experience in using the kiosk. The survey includes steps 1002-1014. At step 1012, the results of the survey are uploaded to a remote server. Such survey results may be uploaded in “real time” as each survey is completed by a user. Alternatively, survey results may be stored locally in the kiosk and uploaded to a server in batch mode.

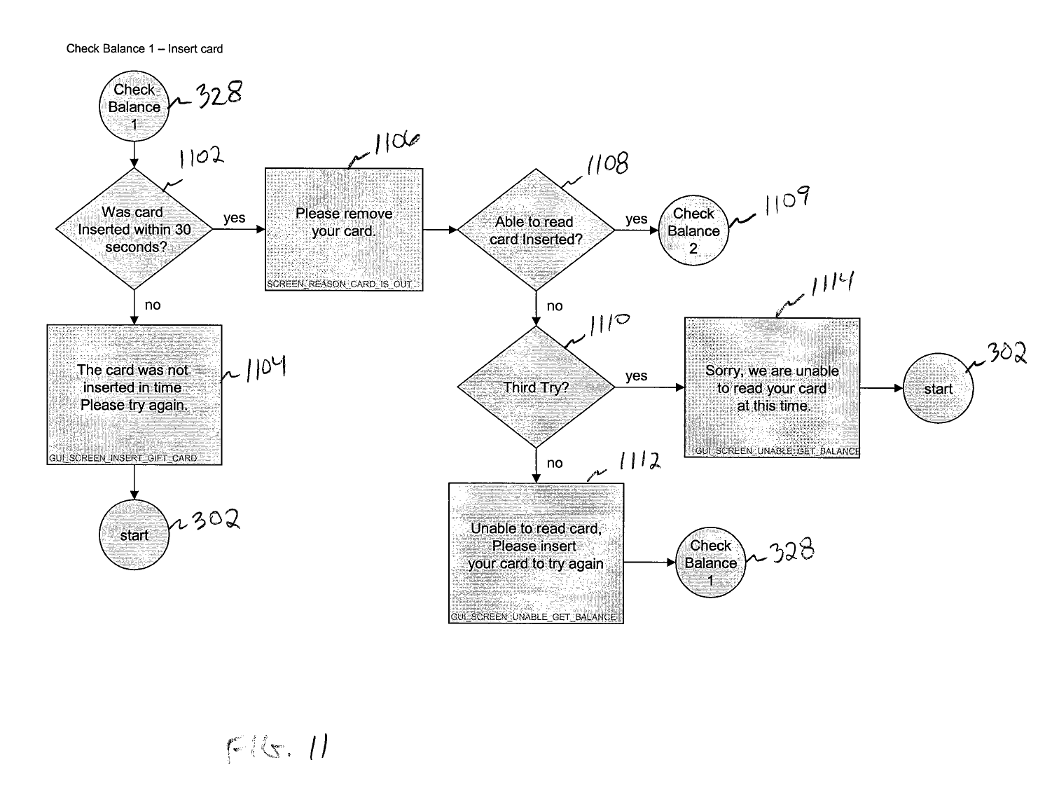

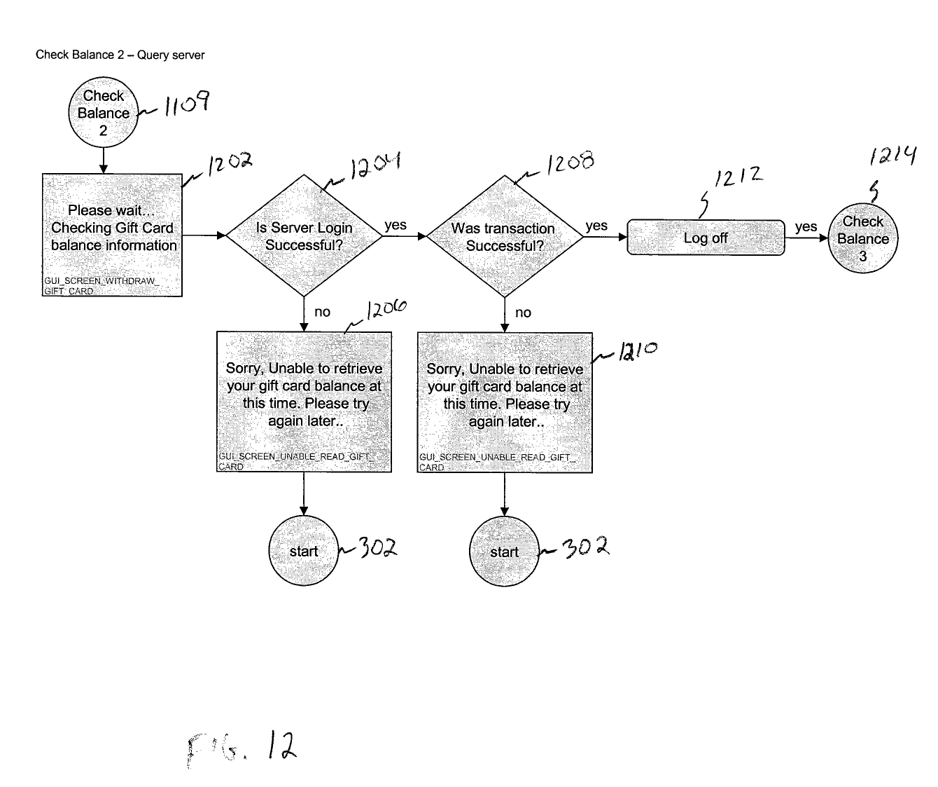

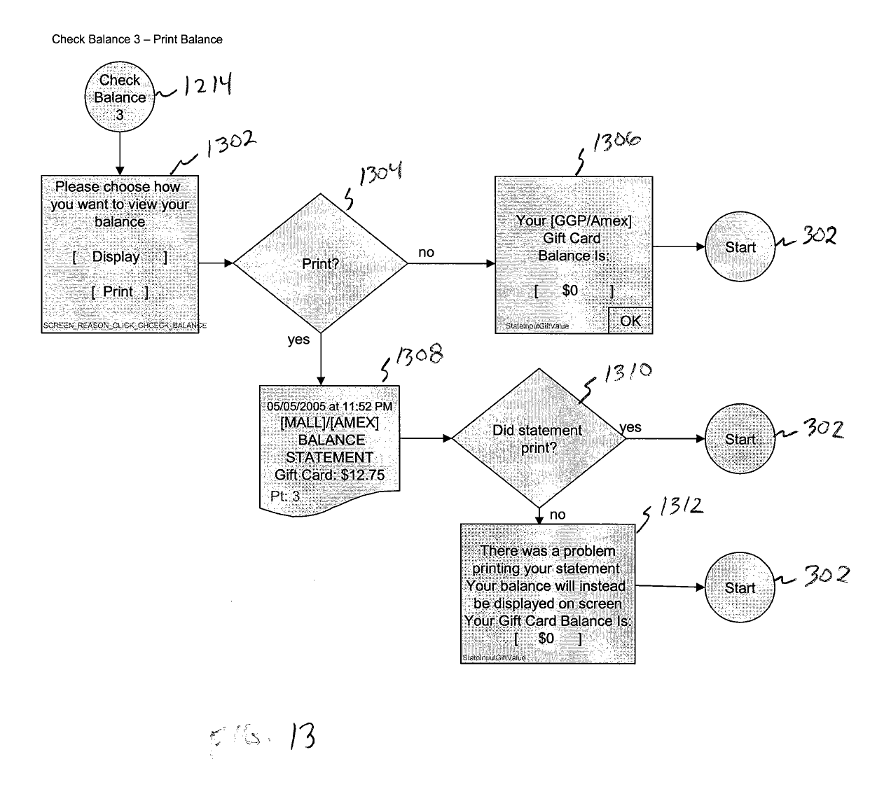

FIGS. 11-13 illustrate the steps of the method for allowing a user to check a balance on a previously purchased stored value card. As shown in FIG. 11, the method include steps 1102-1114. In these steps, a card is received and read. If the card is unable to be read, a message is displayed to the user in step 1114, and the method returns to step 302. If the card is able to be read, the method proceeds to step 1109 in FIG. 12. FIG. 12 depicts steps 1202-1214 where a balance check is performed by querying a remote server. If the balance lookup is not successful, a message is displayed to the user, and the method returns to step 302. If the balance lookup transaction is successful, the method proceeds to step 1214 as shown in FIG. 13. In FIG. 13, the balance is presented to a user via either the display or a printed receipt. This process is illustrated by steps 1302-1312.

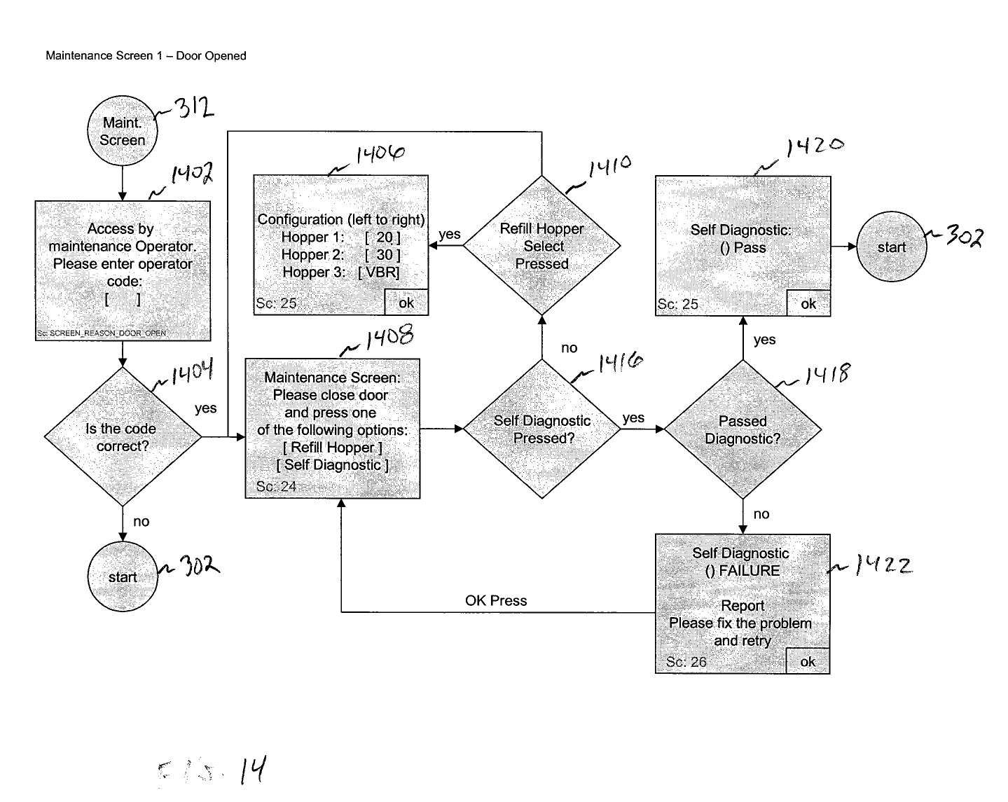

FIG. 14 shows a portion of the method for providing a maintenance interface to a maintenance technician or operator of the kiosk. As shown in FIG. 14, this portion of the method is entered via step 312 (see FIG. 3). In step 1402, a maintenance technician or operator is asked to enter a password (or passcode). If the correct code is entered, the operator is given the option to run self-diagnostic testing and to refill one or more of the hoppers within the kiosk which hold the stored value cardstock. This is represented by steps 1404-1422.

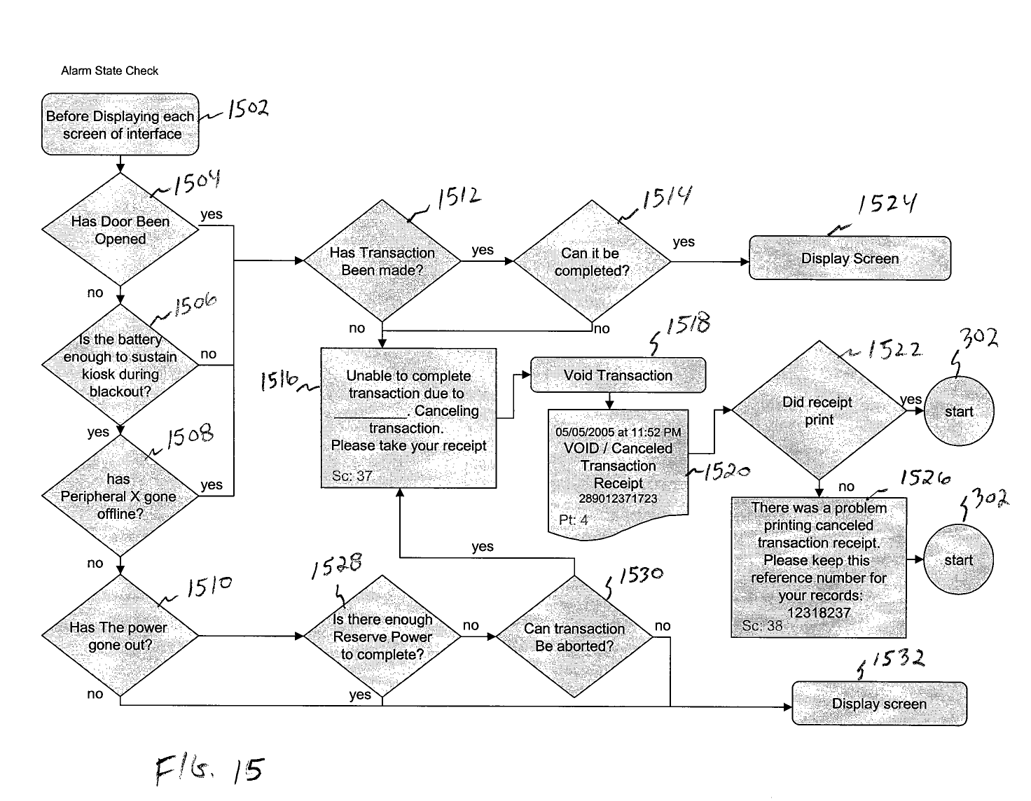

FIG. 15 shows a portion of the method in which an alarm or error state of the kiosk is checked. As indicated in step 1502, before each screen is displayed to a user in each of the steps previously discussed, the method steps of FIG. 15 are performed to determine whether an error or alarm condition exist. For example, it is determined at step 1504 whether the maintenance door of the kiosk has been opened, it is determined in step 1506 whether there is sufficient backup battery power to sustain the kiosk during a power loss of a predetermined length of time, at step 1508 it is determined whether one or more of the peripheral devices (e.g., the card reader, currency acceptor, printer, display, card dispenser, or communication interface) of the kiosk has become unavailable, inoperable or offline, and in step 1510 it is determined whether power is being provided to the kiosk. If the door has not been opened, there is sufficient battery power, no peripheral has gone offline, and power has not been lost, then the desired message will be displayed as indicated by step 1532. Thus, during normal operation, these checks will be made and, assuming normal operation, a message will be displayed as indicated at step 1532. However, if the door has been opened, there is insufficient battery power available or a peripheral has gone offline, then it is determined at steps 1512-1522 whether a transaction has been made and, if a transaction has been made, whether it can be completed or must be voided. Similarly, if step 1510 determines that power has been lost and step 1528 determines that insufficient reserve power is available to complete a transaction, then it is determined at step 1530 whether the transaction can be aborted. If the transaction cannot be aborted, then the transaction continues at step 1532. If the transaction can be aborted, the method proceeds to step 1516 for aborting or cancellation of the transaction.

In this example embodiment of the invention, transaction processing for activation and management of the stored value cards is provided by Stanton Consultancy Limited of Brighton, East Sussex United Kingdom, using their UltraPoS system. UltraPoS is a system for transaction processing of traveler's checks, foreign currency exchange, and prepaid cards. UltraPoS can be deployed as a packaged application or as a hosted ASP (Application Service Provider) service. Additional information on UltraPoS can be found at http://www.scluk.com. In this example embodiment, Stanton Consultancy Limited hosts the UltraPoS system in their London facility. Access to UltraPoS is via the internet. A thin client application running on kiosk 100 interfaces with the UltraPoS system.

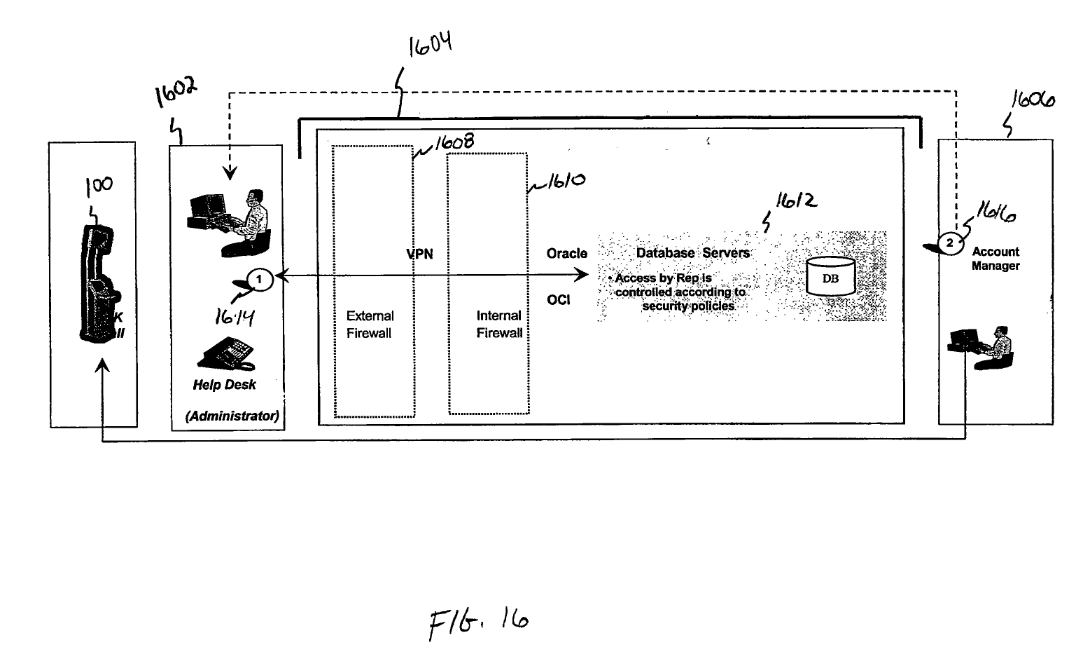

Continuing with this example embodiment of the invention, communication between the kiosk and the transaction processing system (e.g., UltraPoS) is described below with reference to FIGS. 16-22. Referring first to FIG. 16, registration and initiation of a new kiosk 100 is described. Kiosk 100 is placed in a shopping center and is provided with internet access. A transaction processing system 1604 is tasked with transaction processing for the stored value cards. An account manager 1606 is responsible for local management of the kiosk. The account manager can be responsible for ordering card stock, stocking the kiosks, providing card stock number lists to the issuing financial institution (e.g., American Express Company), and settling payment for transactions. The account manager can be a partner of the issuing financial institution or can be a third party providing services to the financial institution and the partner. The transaction processing system 1604 provides database servers 1612 (having databases stored thereon) which are accessible via a virtual private network (VPN) through firewalls 1608 and 1610. The transaction processor 1604 can provide a helpdesk facility 1602 to account manager 1606.

FIG. 16 illustrates communication between kiosk 100, helpdesk 1602, transaction processing system 1604 and account manager 1606 in connection with initiation and setup of a new kiosk. In a first step 1614, helpdesk 1602 assigns the kiosk a user ID and password. The helpdesk 1602 (also called an “administrator”) logs into a maintenance portion of the UltraPoS system and creates a user ID with appropriate access rights. Access by the administrator to the UltraPoS system is via a thick client application interfacing through a VPN to the database server 1612. Passwords are encrypted and stored in the database. Access rights and password parameters are assigned according to a pre-configured profile for the type of user. Username and other details are entered. For example, the other information associated with the user ID may include shopping center ID, merchant ID (to be associated with the kiosk for use in identifying the kiosk in a credit card payment transaction), seller ID (for identifying the kiosk as a seller of a stored value card), and a static IP (internet protocol) address associated with the physical location of the kiosk. Some of this information, such as the physical or static IP address are used for secure identification or fraud control.

In a second step 1616, the administrator contacts the account manager 1606 to communicate the user IDs and passwords. This can be done via telephone, electronic mail or through other means. Account manager 1606 will store the IDs and passwords in a compiled system file. Account manager 1606 then communicates the compiled system file to kiosk 100. Kiosk 100 will use the compiled system file (including the user ID and password) to communicate with the UltraPoS system.

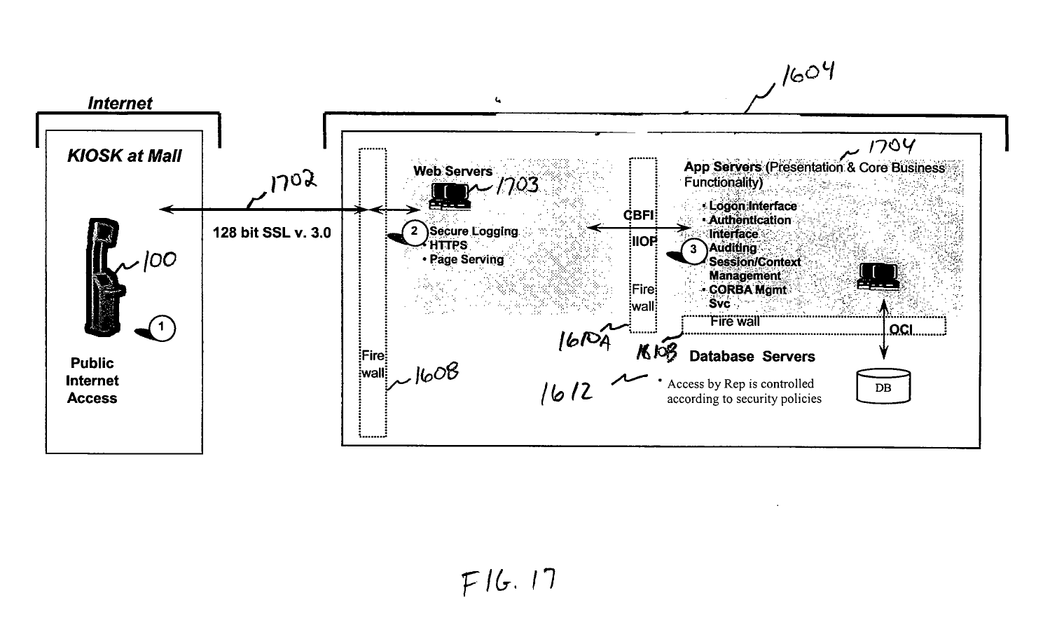

FIG. 17 illustrates communication between kiosk 100 and transaction processing system 1604 (also referred to as the UltraPoS system). Software running on kiosk 100 will log in and logout of the UltraPoS system for each session. The log in will be done by connecting to a predefined URL, passing the user ID and password credentials via an XML message over an HTTPS session. This communication is indicated by reference number 1702. Upon receipt of the credentials from the kiosk, the UltraPoS system will decrypt the values, validate the authentication, and allow a transaction session. Web servers 1703 handle the HTTPS communication using, for example, 128 bit SSL 3.0 encryption. Web server 1704 passes the communication to application server 1704 via a CORBA gateway 1610A. An application server 1704 compares the user ID and password with a user ID and password entry for the particular kiosk at the specified location with an entry in database 1612. Upon successful comparison of the user ID and password, login is established and kiosk 100 is allowed to communicate with a database server 1612.

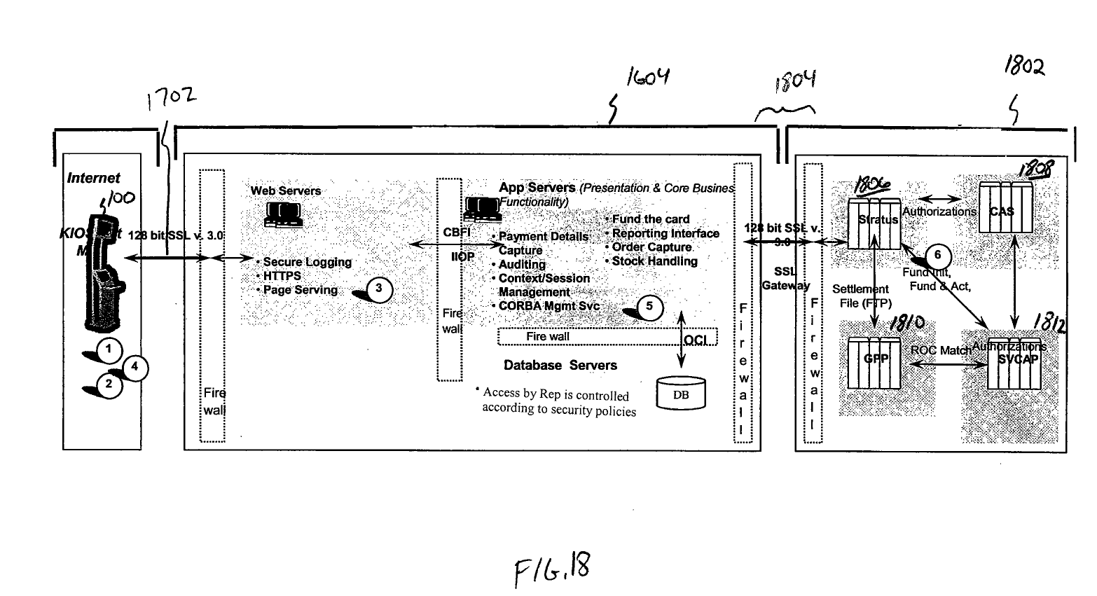

FIG. 18 illustrates processing of a stored value card purchase at kiosk 100 after login has been successfully completed. In connection with a purchase of a stored value card, as illustrated in the method described in the flowcharts above, kiosk 100 will submit a transaction to UltraPoS in XML format. The transaction details include, for example, track data from the stored value card, a denomination amount to be loaded onto the stored value card, track data of the transaction card being used to make the purchase, an amount to be charged to the transaction card, and an indication of the issuer of the transaction card. Upon receipt of this transaction data, the UltraPoS system will verify if the prepaid card is in stock and is valid for sale. If the card is valid, the UltraPoS system will create an ISO message for funding the prepaid card. The ISO message is then sent to the stored value card issuing institution 1802 (e.g., American Express Company) via an SSL gateway 1804. In the example implementation when a stored value card issuing institution 1802 is American Express Company, a Stratus server 1806, a CAS server 1808, a partner server 1810, and an SVCAP server 1812 are used to process the stored value card transactions. These four servers, communicating with one another, approve or deny the funding of the stored value card and send an appropriate response back to the requester. (i.e., via SSL gateway 1804, application servers and web servers of UltraPoS system 1604, and SSL link 1702). The processing performed by servers 1806-1812 is not critical for operation of the present invention. A person skilled in the art will recognize that different issuing institutions will provide different processing methodologies and architectures for approving or denying funding of a stored value card.

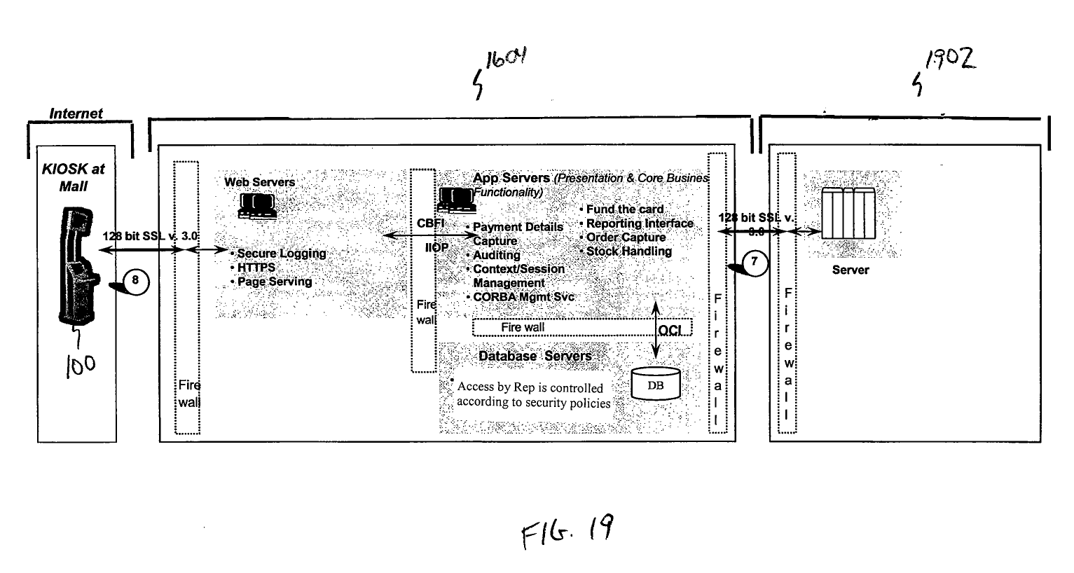

FIG. 19 illustrates communication involved in payment processing in connection with purchase of a stored value card via kiosk 100. After activation is approved by the issuing institution 1802 as discussed in reference to FIG. 18, the UltraPoS system 1604 will process payment. As shown in FIG. 19, the UltraPoS system communicates with a payment processor 1902. In this example, payment processor 1902 is http://www.auth.net. UltraPoS submits, e.g., a credit card transaction to auth.net. If it is successful, an approval code is returned to UltraPoS by auth.net. Once all approvals are in place, UltraPoS will return confirmation to the kiosk. The kiosk will then vend the card and print the receipt for the customer as discussed above.

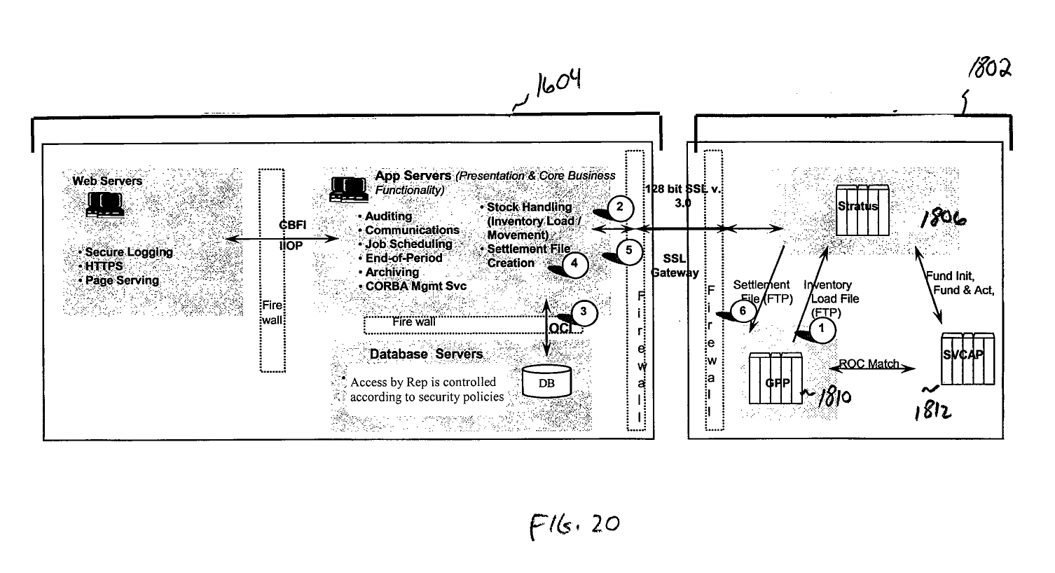

FIG. 20 illustrates communication between the transaction processing system (e.g. UltraPos system) 1604 and the stored value card issuing institution 1802 (e.g., American Express Company) in connection with settlement and inventory load. When stored value card stock or inventory is shipped to account manager 1606 (or whomever else is responsible for loading the cardstock into kiosk 100), an inventory load file is created in partner database 1810. This inventory load file contains the details of the inventory shipped. For example, the details include the card numbers, denomination, merchant number, serial numbers, etc. The partner database 1810 may be maintained, e.g., by a partner company of the issuing institution 1802, wherein the partner company is responsible for management of the stored value cardstock. Thus, the partner company would send the stored value cardstock to the account manager and provide the inventory load file to the issuing institution. At the issuing institution, the inventory load file would be transferred from the partner server 1810 to the Stratus server 1806. An application server at transaction processing system 1604 will then retrieve the inventory load file from Stratus server 1806. The application server then parses the inventory load file and assigns inventory to the appropriate kiosks. In this manner, the application servers of UltraPoS become aware of the cardstock being loaded into a particular kiosk and will then be ready to process transactions involving the particular cards and the cardstock.

The application servers are also responsible for settlement file creation. At a pre-specified time each day, a settlement file is then created for all authorized transactions. This file is sent from the UltraPoS system to the issuing institution 1802. Specifically, the file is sent to Stratus server 1806. The Stratus server then transfers the settlement file to the partner server 1810. The settlement file is then processed according to “business as usual,” as would be apparent to a person skilled in the art, to settle payments for the stored value cards sold during the particular time period.

An additional feature of the invention is velocity checking for fraud control. Velocity checking involves monitoring usage of a particular transaction card being used for kiosk purchase of stored value cards. For example, a stolen transaction card could potentially be used to purchase a plurality of gift cards without requiring “sight verification,” i.e., a visual identification check by a sales person at a point of sale. To limit exposure to such fraudulent transactions, the invention monitors and limits credit card usage. For example, in one embodiment, the invention limits transaction card transactions based on payment amounts and frequency. In this example, use of a particular transaction card for purchase of stored value cards from a kiosk may be limited to no more than three transactions per day, six transactions per week, and ten transactions per month, where each transaction may involve purchase of one or more stored value cards. The particular transaction card can also be limited, for example, to a cumulative daily maximum of $600 for purchase of stored value cards from a kiosk. Such velocity checking can be performed, for example, at the transaction processing system or at the issuing financial institution.

Yet another feature of the invention is its measurement and reporting capabilities. For example, the invention can monitor and record such features as transaction time, abort points, pause points, fraud and vandalism related information, and errors. Transaction time is, for example, a time from a first screen touch by a user until completion of the transaction when a stored value card is dispensed. Tracking transaction times can help determine the efficacy of the kiosk, assess the degree of customer satisfaction, and identify problems.

Abort points include, for example, identification and reporting of the point during a purchase (e.g., the method steps illustrated in FIGS. 3-15) where a user aborts or cancels a purchase. For example, if a substantial number of users are aborting transactions when presented with an option to agree to a transaction fee, it may be inferred that the transaction fee is too large and should be reduced.

Pause points include, for example, identification and reporting of the points during a purchase (e.g., the method steps illustrated in FIGS. 3-15) where a user takes more than a threshold amount of time to respond to a prompt. Such pauses may suggest that the screen presented to the user is confusing and should be re-worked.

Fraud and vandalism related information can also be collected and reported according to the invention. For example, if presented with a reported-stolen transaction card, the kiosk can take one or more photographs of the user. Similarly, a vandal or user “playing” with a kiosk (without apparent intent to make an actual purchase) might also be identified and photographed.

Error measurement and reporting involves monitoring for errors such as an inability to read a transaction card or the inability to determine an card number for a stored value card. Such reporting can speed problem identification and repair.

The measurement and reporting features of the invention may be part of the functionality of the computer programs resident on the kiosk, with periodic uploads (reporting) of data to the transaction processing system and/or the issuing financial institution.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting to the scope of the present invention in any way.

1. A kiosk for vending stored value cards, comprising:
interface means for receiving a request to purchase a stored value card and an indication of a card denomination;
means for receiving payment for the purchase;
means for determining a card number associated with a selected card;
means for activating the selected card to produce an activated stored value card in the card denomination; and
means for dispensing the activated stored value card.

2. The kiosk of claim 1, wherein the interface means comprises:
means for prompting a user to select a type of stored value card, wherein the type is selected from the group consisting of an open card and a closed card; and
means for prompting a user to select a card denomination.

3. The kiosk of claim 2, wherein the interface means further comprises means for surveying a user about the user's experience in using the kiosk; and communication means for uploading results of the survey to a remote server.

4. The kiosk of claim 1, wherein the interface means for receiving a request to purchase a stored value card and an indication of a card denomination comprises:
means for presenting to the user a plurality of fixed denomination card options and receiving from the user an indication of a selected fixed denomination.

5. The kiosk of claim 1, wherein the interface means for receiving a request to purchase a stored value card and an indication of a card denomination comprises:
means for presenting to the user a variable denomination card option and receiving from the user an indication of a desired variable denomination.

6. The kiosk of claim 2, further comprising:
a plurality of card hoppers, wherein each card hopper is configured to contain either a plurality of cards of a similar denomination or a plurality of cards for variable load.

7. A kiosk for vending a stored value card, comprising:
(a) an interface device;
(b) a card supply sub-system;
(c) a communication sub-system to provide communication with a network; and
(d) a digital processor to:
(i) control the interface device to receive from a user a request to purchase a stored value card, a requested denomination, and a payment vehicle,
(ii) determine a card number associated with a selected card,
(iii) communicate, via the communication sub-system, with a remote server on the network to activate the selected card to produce an activated stored value card in the card denomination; and
(iv) control the card supply sub-system to dispense the activated stored value card.

8. The kiosk of claim 7, wherein the interface device comprises a touch-sensitive display and a card reader.

9. The kiosk of claim 7, wherein the card supply sub-system includes a card, a plurality of card hoppers, and a card dispensing device.

10. The kiosk of claim 7, wherein the communication sub-system comprises at least one of a dial-up modem, a cable modem, a wireless modem, and an Ethernet card.

11. A method for automatically vending a stored value card, comprising:
providing a kiosk having a user interface;
receiving, via the user interface, a request to purchase a stored value card;
receiving payment for the purchase;
determining a card number associated with a selected card;
activating the selected card to produce an activated stored value card in a card denomination; and
dispensing the activated stored value card.

12. The method of claim 11, wherein the request receiving step comprises:
receiving, via the user interface, a request to purchase a stored value card, wherein the request indicates a type of stored value card.

13. The method of claim 12, wherein the request receiving step comprises:
receiving, via the user interface, a request to purchase a stored value card, wherein the request indicates a type of stored value card, and wherein the type is selected from the group consisting of an open card and a closed card.

14. The method of claim 13, wherein the request receiving step further comprises:
receiving, via the user interface, an indication of a card denomination, wherein the card denomination is variable and is user selectable.

15. The method of claim 13, wherein the request receiving step further comprises:
receiving, via the user interface, an indication of a card denomination, wherein the card denomination is fixed and is user selectable from a plurality of fixed denomination options.

16. The method of claim 11, wherein the request receiving step further comprises:
receiving, via the user interface, an indication of a card denomination.

17. The method of claim 16, wherein the request receiving step further comprises:
receiving, via the user interface, an indication of a card denomination, wherein the card denomination is variable and is user selectable.

18. The method of claim 11, further comprising a step occurring prior to the payment receiving step of:
receiving, via the user interface, an acceptance of a service fee.

19. The method of claim 11, wherein the payment receiving step comprises:
receiving payment card information; and
processing the payment card information to effect payment for the purchase.

20. The method of claim 19, wherein the payment receiving step further comprises at least one of capturing a photographic image of a user providing the payment card information or receiving, via the user interface, identifying information from the user.

21. The method of claim 11, wherein the determining step comprises at least one of reading the selected card to determine the card number or retrieving the card number from a database.

22. The method of claim 11, wherein the activating step comprises:
sending to a remote server a request to activate the selected card; and
receiving from the remote server an activation acknowledgement.

23. The method of claim 11, wherein the dispensing step comprises:
selecting a card from a selected card hopper of a plurality of card hoppers, wherein each card hopper is configured to contain either a card of a similar denomination or a card for variable load.

24. The method of claim 11, further comprising:
surveying, via the user interface, a user about the user's experience in using the kiosk; and
uploading results of the survey to a remote server.

25. The method of claim 11, further comprising:
reading a card number from a stored value card;
transmitting the card number to a remote server;
receiving from the remote server a card balance for the stored value card; and
reporting the card balance to a user.

26. The method of claim 25, wherein the reporting step comprises at least one of displaying the card balance on the user interface; and printing the card balance on a receipt provided to the user.

27. The method of claim 11, wherein the payment receiving step further comprises:
performing a velocity check.
